(19) United States
(12) Patent Application Publication
(10) Pub. No.: US 2008/0270984 A1
(43) Pub. Date: Oct. 30, 2008

(54) Script program execution device, script program execution method, and optical disk device

(76) Inventor: Hideyuki Tsutsumitake, Yokohama-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/644,482

(22) Filed: Dec. 21, 2006

(30) Foreign Application Priority Data
Dec. 27, 2005 (JP) 2005-374601

(51) Int. Cl. G06F 9/44

(52) U.S. Cl. 717/115

(57) ABSTRACT

A script program execution device comprises an analysis unit which beforehand reads a script program, to analyze a syntax of the script program, before the execution of the script program is instructed, a storage unit which stores a syntax analysis result of the analysis unit, a generation unit which generates an intermediate code from the script program by use of the syntax analysis result stored in the storage unit, when the execution of the script program is instructed, and an execution unit which executes the intermediate code generated by the generation unit. According to this device, an application described in a script language is started and switched at a high speed.

### CROSS-REFERENCE TO RELATED APPLICATIONS

This application is based upon and claims the benefit of priority from Japanese Patent Application No. 2005-374601, filed Dec. 27, 2005, the entire contents of which are incorporated herein by reference.

### BACKGROUND

1. Field

The present invention relates to a method of executing a script program used in a high definition DVD (HD DVD) and the like and described in a script language.

2. Description of the Related Art

Heretofore, there has existed a script language as a program language which does not depend on specific platforms (basic portions such as hardware of a CPU and the like and OS). In compilation type languages such as C and C++, compilation processing is required to generate an object code specified for each platform from a source code. On the other hand, in the script language, the source code is read and executed by a processing system referred to as an interpreter.

Unlike the compilation type language, the script language has a mechanism in which the source code is directly executed by the interpreter. Therefore, programming which does not depend on any platform is possible. Examples of such a script language include JavaScript (Mozilla), JScript (Microsoft Co., Ltd.), and Action Script (Adobe Co., Ltd.) broadly used in a web browser.

A general constitution of the interpreter which executes the script language is constituted of a syntax analysis unit which reads the source code and which analyzes a syntax structure to convert it into an internal representation; a code generation unit which generates an intermediate code (or referred to as a virtual code) by use of a syntax tree as a result of the syntax analysis; and an execution engine (referred to as a virtual machine) which executes the generated code. There is also a system of directly executing the syntax tree without generating any intermediate code, depending on a mounting system of the interpreter. However, in this case, there is a defect that an execution speed is low as compared with a case where the intermediate code is generated. Therefore, in many processing systems, a system to generate the intermediate code is generally used.

In Jpn. Pat. Appln. KOKAI Publication No. 1-144127, a program execution method of an interpreter system is disclosed in which a source program is interpreted to store an intermediate language file.

Also in an HD DVD player, the script language is employed in a dynamic operation description of contents and the like. Here, the dynamic operation description means that, for example, as an operation in a case where a skip button of a remote controller is pressed, the program is described to execute an operation of skipping reproduction in certain contents, and to execute an operation of moving a cursor in other contents. The script language which is employed in the HD DVD is based on a standard referred to as ECMA 262 (hereinafter referred to as the ECMAscript).

The ECMAscript does not have anything corresponds to an object file which can generally be used in compiler languages such as C and C++. Therefore, every time a new application is executed, a series of processes are required such as the syntax analysis and the generation of the intermediate code so that the script is read from the source file to execute the same.

In Patent Document 1 described above, the interpreter beforehand assigns a unique name to the source program, and checks whether or not there is an intermediate language file, when the execution of the source program is requested. If the intermediate language file is present, the source program is executed using the intermediate language file.

The ECMAscript does not have any library forming function. Therefore, even when a plurality of applications use a common function, processes such as the syntax analysis and the intermediate code generation are required for each application. In the ECMAscript, a different function can actually be defined using the same function name. Therefore, even when a plurality of source programs use the functions having the same function name, the functions sometimes differ from one another.

Therefore, in the conventional script language processing system, when the application is executed, a series of processes are required such as the reading of the source file, the syntax analysis and the intermediate code generation. Therefore, much time is required to start and switch the application. Furthermore, even when the separate applications utilize the same function, separate processes are performed. In consequence, there is a problem that a memory is consumed more than necessary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a schematic constitution of a script program execution device 100 of the present invention;

FIG. 2 is a flow chart showing a flow of processing from read of a script file to execution of the same;

FIG. 3 is a flow chart showing recursive processing to execute an intermediate code of a function;

FIG. 4 is a diagram conceptually showing an operation to delete, from a memory, a syntax tree of a function converted into an intermediate code;

FIG. 5 is a diagram showing a specific example of processing to judge equivalences of functions;

FIG. 6 is a diagram conceptually showing a behavior in which an intermediate code is shared among programs;

FIG. 7 is a flow chart showing operations of an intermediate code generation unit 105 and an equivalence judgment unit 106;

FIG. 8 is a block diagram showing a schematic constitution of an optical disk device 1 to which the present invention is applied; and

FIG. 9 is a diagram showing a data structure concerning a script for use in an HD DVD.

### DETAILED DESCRIPTION

Various embodiments according to the invention will be described hereinafter with reference to the accompanying drawings. In general, according to one embodiment of the invention, there is provided a script program execution device comprising an analysis unit which beforehand reads a script program to analyze a syntax of the script program, before execution of the script program is instructed; a storage unit which stores a syntax analysis result of the analysis unit; a generation unit which generates an intermediate code from the script program by use of the syntax analysis result stored in the storage unit, when the execution of the script program is instructed; and an execution unit which executes the intermediate code generated by the generation unit.

According to this execution device, an application described in a script language is started and switched at a high speed.

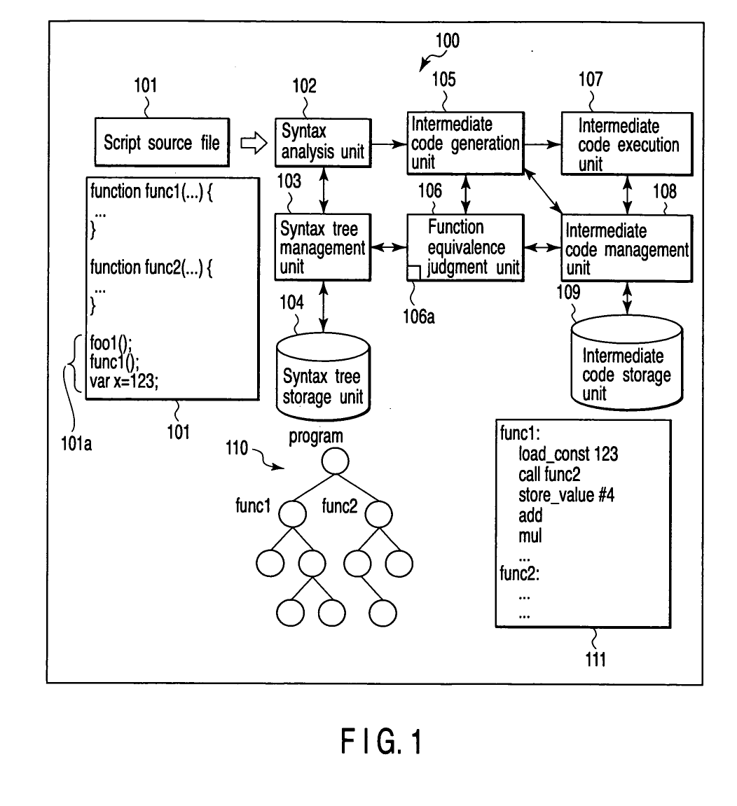

FIG. 1 is a block diagram showing a schematic constitution of a script program execution device 100 of the present invention. This script program execution device 100 may be loaded as software in a memory or constituted as hardware.

A script source file (hereinafter referred to as the script file) 101 is usually given as the ASCII text file or UNICODE text file. This script file is supplied to a syntax analysis unit 102 to construct a tree-like data structure referred to as a syntax tree. A syntax tree 110 is obtained by converting a grammatical element of a program into a tree structure. The generated syntax tree 110 is held by a syntax tree storage unit 104, and the syntax tree is managed by a syntax tree management unit 103. Processing to generate the syntax tree 110 from the script file 101 is irrespective of the execution of a script itself. At a point of time when the script file is given, the file is converted into the syntax tree 110 irrespective of an instruction for execution of the script, and held by the syntax tree storage unit 104.

Next, an intermediate code generation unit 105 generates, from this syntax tree 110, an intermediate code 111 which is a command code of a virtual machine. The intermediate code 111 is associated with each function by an intermediate code management unit 108, and stored in an intermediate code storage unit 109. The generated intermediate code 111 is executed by an intermediate code execution unit (virtual machine) 107. The execution of the script means executing the intermediate code 111.

In the ECMAscript employed in an HD DVD player, the script is constituted of function definition and a described code referred to as a global code other than the function. A portion of the script which is first executed is this global code. The global code is a code which does not belong to any function, but is virtually interpreted as a code of a function referred to as global. The function equivalence judgment unit 106 judges whether or not separate functions are equivalent to one another.

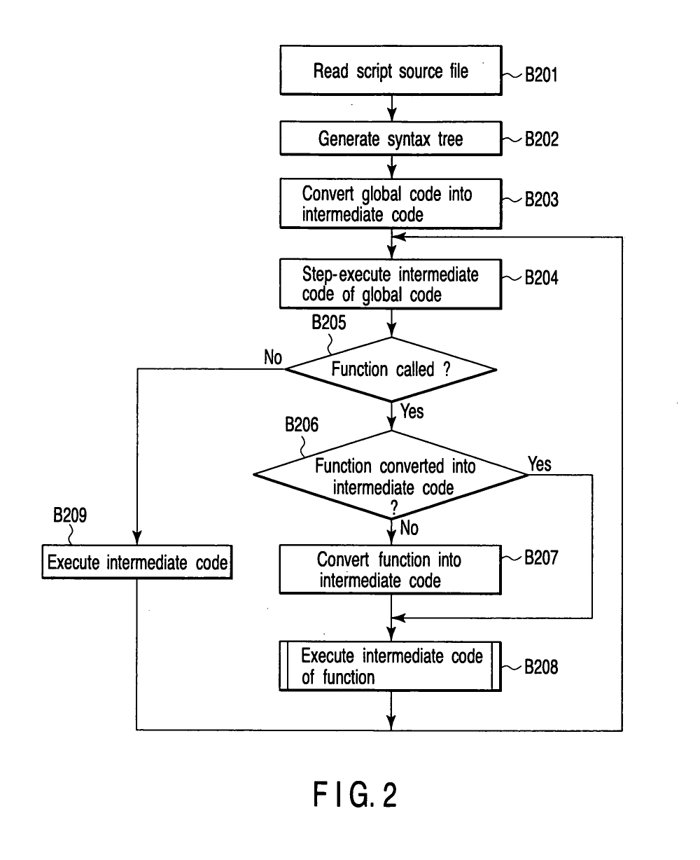

FIG. 2 is a flow chart showing a flow of processing in which the script file, that is, the script program is read and executed using the above-described constitution.

First, the syntax analysis unit 102 reads the script file 101 (B201) to generate the syntax tree 110 (B202). The generated syntax tree is stored in the syntax tree storage unit 104 by the syntax tree management unit 103. These processings (B201, B202) are performed before the execution of the script program is instructed (before the device is started). The generation of the syntax tree 110 makes it possible to judge which portion of the script program is the function and which thereof is the global code. The global code is denoted by 100a in the script file 101 shown in FIG. 1.

When the execution of the program is instructed, the intermediate code generation unit 105 converts the global code into the intermediate code (B203). This intermediate code is transferred to the intermediate code execution unit 107, and stored in the intermediate code storage unit 109 by the intermediate code management unit 108. The intermediate code execution unit 107 step-executes the global code converted into the intermediate code (B204). Here, the step-execution means that the intermediate code is successively executed while being interpreted. It is checked whether or not the interpreted intermediate code is function calling (B205). When the intermediate code is the function calling, the intermediate code execution unit 107 simply executes the intermediate code (B209). When it is the function calling, the function equivalence judgment unit 106 checks whether or not its function main body has already been converted into the intermediate code (B206). When the function main body is not converted, the intermediate code generation unit 105 converts the function main body into the intermediate code (B207), and the intermediate code execution unit 107 executes the converted intermediate code (B208). The execution of this intermediate code sometimes involves further other function calling during the execution, and is recursive processing.

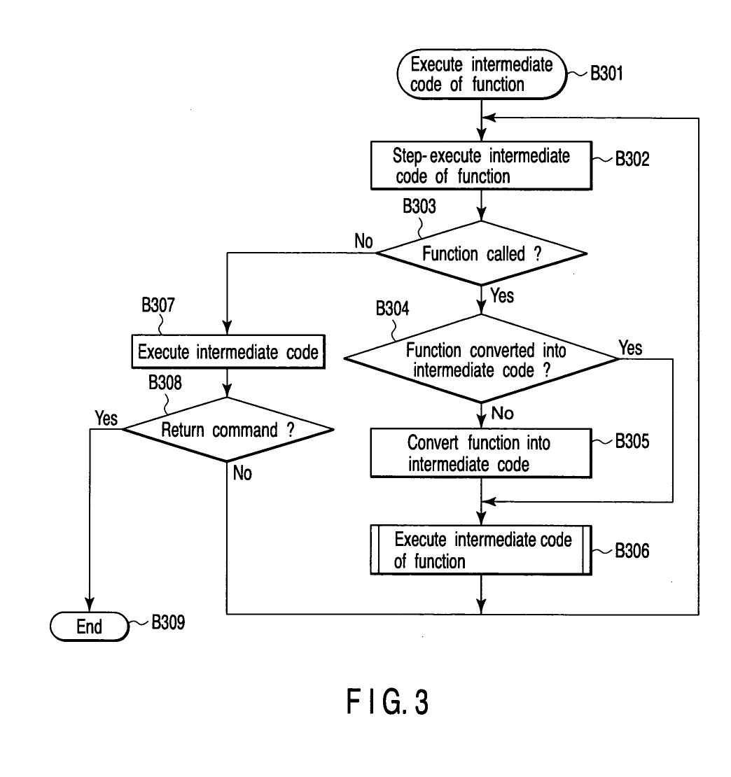

Next, there will be described the recursive processing to execute the intermediate code of the function in the block B208. FIG. 3 is a flow chart showing this processing.

In a block B302, in the same manner as in the processing of the global code, the intermediate code execution unit 107 step-executes the intermediate code of the function. It is checked whether or not the intermediate code is the function calling (B303). When the intermediate code is not the function calling, the intermediate code execution unit 107 executes the intermediate code (B307). Moreover, it is checked whether or not the code is a return command (B308). When the code is the return command, the intermediate code execution unit 107 ends the processing (B309).

On the other hand, when the intermediate code is the function calling, the function equivalence judgment unit 106 checks whether or not the function has been converted into the intermediate code (B304). When the function is not converted, the intermediate code generation unit 105 converts the function into the intermediate code (B305). Moreover, the intermediate code execution unit 107 recursively executes the intermediate code of the function (B306).

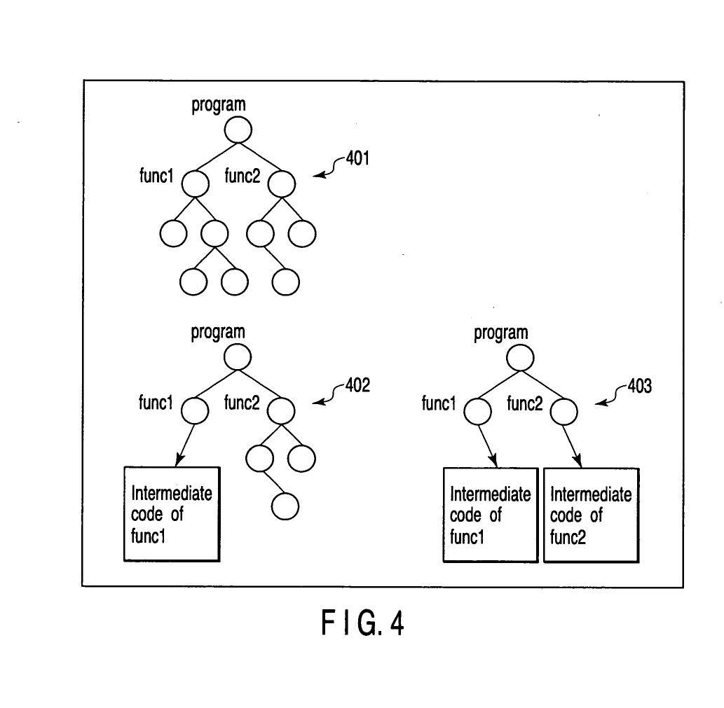

Although not shown herein, the syntax tree of the function once converted into the intermediate code may be deleted from a memory. FIG. 4 conceptually shows the operation. Here, an application (program) is constituted of a function func1 and a function func2 (state 401). First, the function func1 is converted into the intermediate code, and the syntax tree corresponding to the function func1 is deleted (state 402). Next, the function func2 is called to generate the intermediate code, and the corresponding syntax tree is deleted (state 403).

Next, there will be described a system in which in a case where a common function is used by separate applications, the function is shared among these applications. In the ECMAscript, unlike program languages such as C and C++, even functions having the same function name can be redefined as separate functions during execution. Therefore, equivalence of the function cannot be judged by the function name only, and it is necessary to check the code of the function main body. Here, as the judgment of the equivalence of the function, replacement of a variable name, unification of a block sentence and replacement of a reserved word are performed. Based on the equivalence of the resultant character string, the equivalence of the function is judged.

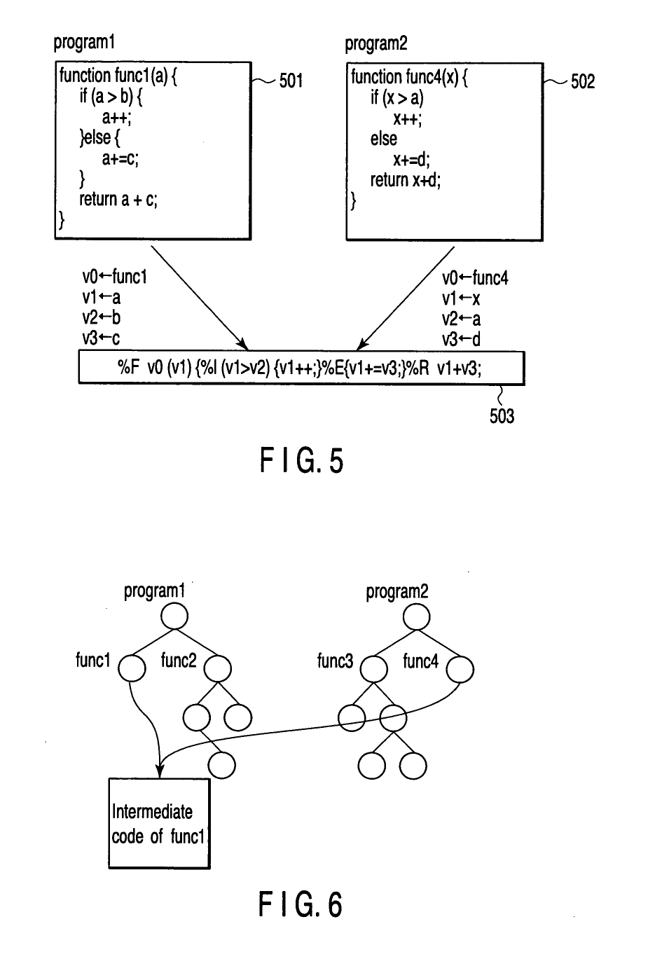

FIG. 5 shows a specific example of the judgment of the equivalences of the functions.

Programs program1 (501) and program2 (502) are converted into a character string 503 by the above-described judgment process of the present application, and it is understood that the function func1 is the same as a function func4. Here, in the program1, the function name func1 is replaced with v0, and variables a, b and c are replaced with v1, v2 and v3, respectively. In the program2, the function name func4 is replaced with v0, and variables x, a and d are converted into v1, v2 and v3, respectively. Reserved words function, if, else and return are replaced with %F, %I, %E and %R, respectively. The other reserved words are similarly converted. In a sentence such as an if sentence, a block sentence surely including ‘{’ and ‘}’ is used, and a plurality of continuous blanks are normalized into one blank. Thus, normalization is performed. A character string representation converted in this manner will hereinafter be referred to as a standard normalized character string of the function.

The function equivalence judgment unit 106 stores the thus obtained standard normalized character string in a register 106a together with the function name. When the function calling occurs during the later execution of the application, the function equivalence judgment unit 106 compares the standard normalized character string of the called function with that of the function stored in the register 106a to judge the equivalences of the functions.

When it is judged that the func1 and the func4 are the same functions in the program1 and the program2, the intermediate codes can be shared. FIG. 6 conceptually shows the behavior. The func1 of the program1 is converted into the intermediate code, and the func4 of the program2 is called during execution. At this time, the func4 is not converted into the intermediate code yet. When the function equivalence judgment unit 106 judges that the func4 is equivalent to the func1, instead of generating the intermediate code of the func4, the intermediate code of the func1 is read from the intermediate code storage unit 109 to share the intermediate code.

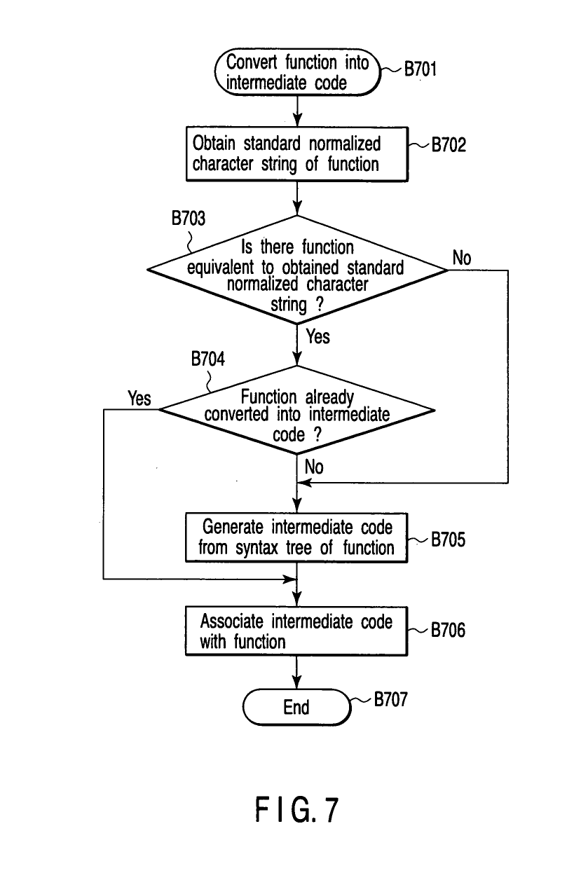

FIG. 7 is a flow chart showing operations of the intermediate code generation unit 105 which convert the function into the intermediate code and the equivalence judgment unit 106.

First, as described with reference to FIG. 5, the function equivalence judgment unit 106 obtains the standard normalized character string of the function (B702). Next, the register 106a is checked to judge whether or not there is a function which is equivalent to the obtained standard normalized character string (B703). When there is not any equivalent function, the intermediate code generation unit 105 generates the intermediate code from the syntax tree of the present function (B705), and associates the intermediate code with the function to store it in the intermediate code storage unit 109 (B706). The generated intermediate code is transferred to the intermediate code execution unit 107 and executed.

To store the intermediate code in the intermediate code storage unit 109, a comparatively large memory capacity is required. Therefore, owing to a restriction on the memory capacity, the intermediate code is sometimes removed after once executed. Therefore, when there is a function equivalent to the standard normalized character string, it is checked whether or not the function has been converted into the intermediate code (whether or not the code is stored in the intermediate code storage unit 109) (B704). When the function is not converted, the syntax tree is converted into the intermediate code (B705). When it is judged in the block B704 that the function is converted, the converted intermediate code is shared (B706). That is, the intermediate code corresponding to the present function is read from the intermediate code storage unit 109, and transferred to the intermediate code execution unit 107.

In general, since the processing for generating the intermediate code from the syntax tree requires a large memory capacity and a long processing time, costs increase very much. Therefore, in a case where the intermediate code has already been generated with the equivalent function as in the present invention, useless processing can largely be omitted by executing the processing in which the intermediate code is shared. When the equivalence of the function is judged by comparison of the character strings, it is possible to use a high speed conventional technique such as hash search. It is to be noted that, in the equivalence judgment of the function, instead of the direct comparison of the standard normalized character strings, the comparison of the character strings may be replaced with mutual comparison of numeric values by use of an one-way hash function such as MD5.

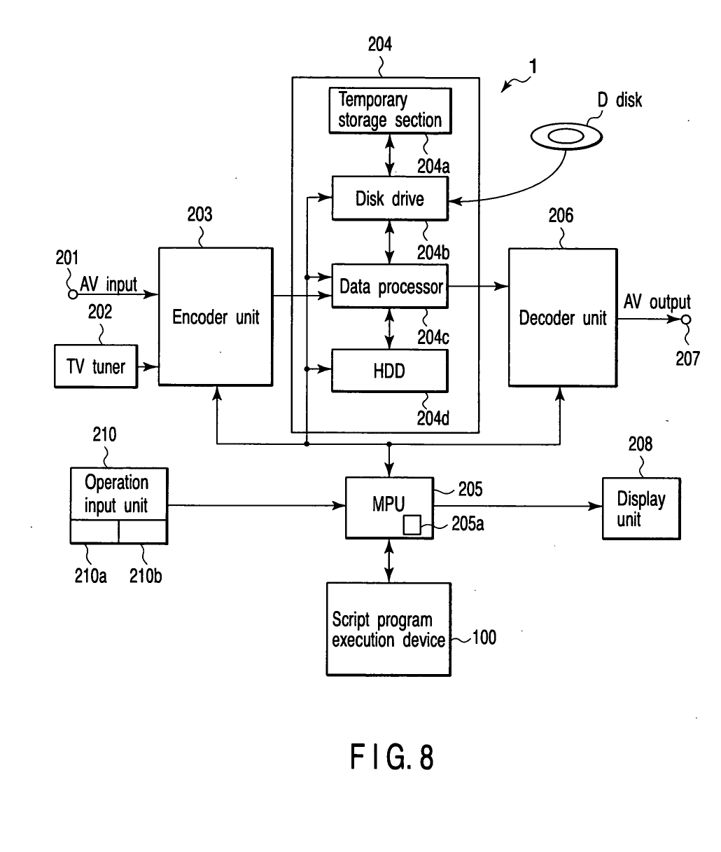

Next, there will be described an embodiment at a time when the present invention is applied to an optical disk device. FIG. 8 is a block diagram showing a schematic constitution of an optical disk device 1 to which the present invention is applied.

The optical disk device 1 records and reproduces video, voice and other information (hereinafter referred to simply as the information or the video information) with respect to an optical disk such as a DVD or an HD DVD. The optical disk device 1 includes a recording/reproducing unit 204 which records the video information in a predetermined optical disk and which reproduces the video information already recorded in the optical disk, the script program execution device 100 of the present invention, and a main processing unit (MPU) 205 which controls operations of the respective units of the present optical disk device 1. The MPU 205 includes an ROM including various control programs, and an RAM which is used as a work area in a case where the control program is executed.

The recording/reproducing unit 204 includes a disk drive unit 204b capable of recording information in a disk D and reproducing the information by use of a light beam, a temporary recording section 204a which temporarily holds a certain amount of the information to be recorded in the disk D set in the disk drive unit 204b or the information reproduced from the disk D, an HDD 204d capable of recording a large capacity of data, and a data processor 204c.

The data processor 204c is controlled by the MPU 205 to supply recording data output from an encoder 203 to the disk drive unit 204b or to supply a reproduction signal of the disk D from the disk drive unit 204b to a decoder 206. Alternatively, the data processor 204c is controlled by the MPU 205 to supply the recording data output from the encoder 203 to the HDD 204d or supply the reproduction signal from the HDD 204d to the decoder 206.

The encoder 203 encodes (compresses) an input video signal. The encoder 203 is connected to an AV input terminal 201 for inputting the video signal as a recording object from the outside, and a tuner 202 capable of receiving the video information distributed from an information distributor represented by, for example, a broadcasting company or the like.

The decoder 206 decodes (extends) the video information output from the recording/reproducing unit 204. The decoder 206 is connected to an AV output terminal 207 for supplying decoded reproduction information to a monitor device such as a television set.

The MPU 205 is connected to an operation input unit 210 which accepts an instruction (operation input) from a user. The operation input unit 210 includes a data receiving section 210a which accepts a control signal transmitted from a remote controller (remote control terminal) (not shown), and an operation panel 210b capable of accepting the direct input from the user to output the control signal to the MPU 205.

In the following description, the disk D is an HD DVD disk in which a plurality of video contents such as movies are beforehand recorded.

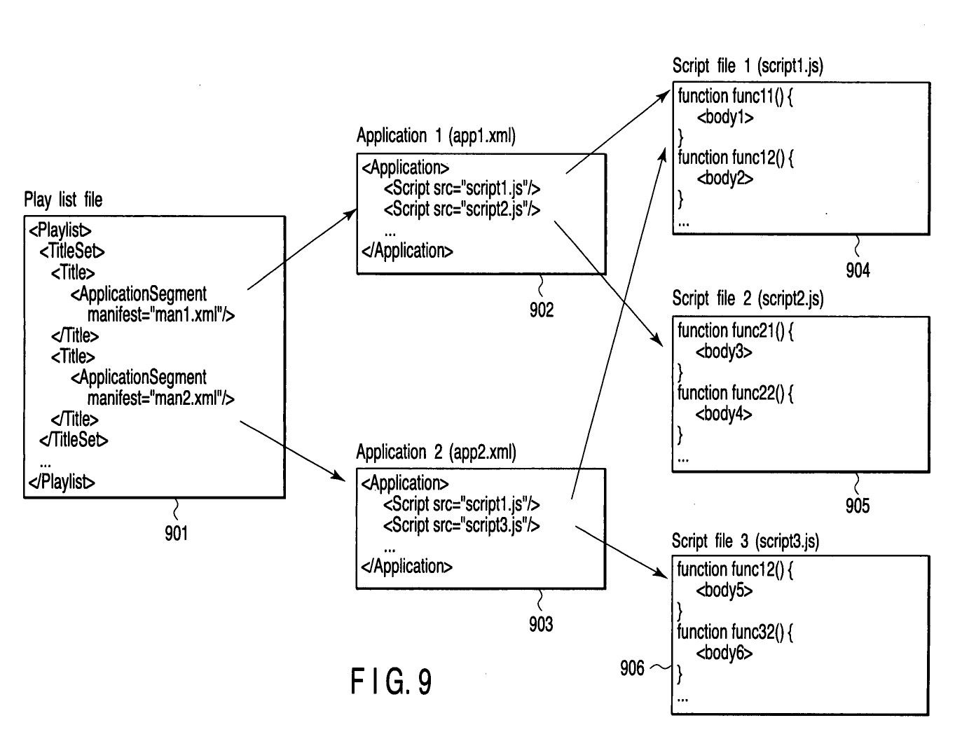

FIG. 9 is a diagram showing a data structure regarding a script for use in the HD DVD. The data is recorded together with other management information of the disk in an inner periphery of the HD DVD, and first read out immediately after the disk D is inserted into the device.

In the HD DVD, information on the contents is described in a file of an XML form referred to as a play list 901. In the play list, there are descriptions to designate a plurality of applications 902, 903. Each application is represented by data of the XML form referred to as a manifest. For example, FIG. 9 shows that in a title (Title) first described in the play list 901, that is, the video contents, a manifest “man1.xml” is designated, and this manifest is linked to an application 1 (app1.xml) of the application 902. This application includes, for example, a program to display a menu.

In each manifest file (application), one or more script files 904, 905 and 906 can be designated. A plurality of script files are gathered up and executed as one application. That is, a script file 1 (904) and a script file 2 (905) are gathered up to constitute one application (902). Separately, the script file 1 (904) and a script file 3 (906) are gathered up to constitute another application (903).

When the disk D is inserted into the disk drive unit 204b of the optical disk device 1, the MPU 205 can read a play list file to supply the file to the syntax analysis unit 102. Therefore, all of necessary script files (here, script1.js, script2.js and script3.js) can be known before reproducing the video contents. In each script file, for example, processing at a time when a skip button of a remote controller (not shown) is pressed is described as the program.

In this way, when the disk D is inserted into the disk drive 204b, the MPU 205 reads management information including the script file from the disk D, and converts the script file into the syntax tree by use of the syntax analysis unit 102 of the script program execution device 100. That is, the blocks B201 and B202 of FIG. 2 are here executed, and the prepared syntax tree is stored in the syntax tree storage unit 104. When the management information of the disk is read and settings of the respective units of the device are completed, the input from the user is possible. When the user inputs an application execution instruction via the operation input unit 210, the processing of the blocks B203 to B209 of FIG. 2 is executed.

When the syntax analysis of the script is performed in this way before starting the application, the processing for starting and switching the application is only the generation of an intermediate code, so that the processing at a higher speed is realized. Furthermore, when the syntax analysis result is held and the function is called, the function is successively converted into the intermediate code, whereby the function can be started at the high speed.

The optical disk device 1 has a resume function. When the user reproduces one title from a plurality of titles recorded in the disk D, interrupts the reproduction of the title halfway, and cuts a power supply of the device 1, information of the title (finally reproduced title) is stored. Subsequently, when the user turns on the power supply of the optical disk device 1 and presses a reproduction button of the remote controller, the information of the finally reproduced title is read out, and the reproduction is resumed from an interrupted position of the title. In this way, a function of storing the information of the finally reproduced title and resuming the reproduction of the finally reproduced title in response to the instruction for the reproduction is referred to as the resume function. This resume function is executed by a resume section 205a disposed in the MPU 205.

When a large number of the script files are present in the disk D inserted into the optical disk device 1, the script presumed to be first executed may preferentially be selected and converted into the syntax tree. When a script of the finally reproduced title is preferentially beforehand subjected to syntax analysis as such a script, a time for starting the application is shortened. The information of the finally reproduced title is judged using the information stored by the resume function. This is effective means because there are many use scenes where the finally reproduced title is also reproduced at the next start.

Description will be made returning to FIG. 9. The script file 1 is referred to by both of the applications 1 and 2. This can be judged because actual file names are the same (script1.js). When the application 1 is executed, functions func11 and func12 in the script file 1 are converted into intermediate codes and held in a memory (intermediate code storage unit 109).

When the application 2 is next executed, the same file script1.js as that of the application 1 is read. At this time, the intermediate code of the function func11 can be shared, but the intermediate code of the function func12 cannot simply be shared. This is because the function func12 is redefined in the script file 3 (script3.js). That is, the functions having the same name in different files are not always executed as the equivalent functions. Moreover, the functions having the same name in the same file are not always executed as the equivalent functions. Furthermore, the functions having different function names actually have the same function in some cases. Therefore, as described with reference to FIG. 5, it is checked by use of the function equivalence judgment unit 106 of the present invention whether or not the function func12 of the script file 1 is equivalent to the function func12 of the script file 3 in FIG. 9. When they are equivalent, the intermediate code is shared. When they are not equivalent, an intermediate code is newly generated.

On the other hand, the script file 2 is separate from the script file 3. Therefore, even when the function name differs as described above, the operations of the function main bodies might be the same. Now, if the standard normalized character string of a function func21 is the same as that of a function func32, it is judged that both the functions are the same. In a case where the application 1 is already executed and the function func21 is converted into the intermediate code, the function func32 does not have to be converted into the intermediate code when the application 2 is executed. The intermediate code of the function func21 can be reused.

In a case where the functions judged to be the same function by the function equivalence judgment unit 106 are used by a plurality of applications, the generated intermediate code is shared, whereby intermediate code generation processing with a very high processing cost can be omitted, and an increase of the speed in starting the function and a decrease of an amount of the memory for use can be realized.

The above description is the embodiments of the present invention, and the apparatus and the method of the present invention are not limited thereto, and various modified examples can be implemented. Such modified examples are included in the present invention. Further, apparatuses or methods which are configured by appropriately combining the components, the functions, the features, or the steps of the method in the respective embodiments are included in the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A script program execution device which executes a script program described in a script language, the script program execution device comprising:
an analysis unit which beforehand reads the script program to analyze a syntax of the script program, before the execution of the script program is instructed;
a storage unit which stores a syntax analysis result of the analysis unit;
a generation unit which generates an intermediate code from the script program by use of the syntax analysis result stored in the storage unit, when the execution of the script program is instructed; and
an execution unit which executes the intermediate code generated by the generation unit.

2. The script program execution device according to claim 1, in which the script program includes a plurality of functions and the intermediate code generation unit generates the intermediate codes of the functions, the script program execution device further comprising:
a judgment unit which judges equivalences of the functions,
wherein in a case where the judgment unit judges that the functions equivalent to each other are present in the script program, the execution unit shares the intermediate code of a function generated by the execution of one function, during the execution of the other function.

3. The script program execution device according to claim 1, wherein the script program is a program described by an ECMAscript.

4. The script program execution device according to claim 2, wherein the script program is a program described by an ECMAscript.

5. An optical disk device to reproduce an optical disk in which an application including a plurality of script programs is recorded, the optical disk device comprising:
a disk drive which reproduces, by use of a light beam, information recorded in the optical disk;
a reading unit which beforehand reads the script program from the optical disk, when the optical disk is inserted into the disk drive;
an analysis unit which analyzes a syntax of the script program read by the reading unit;
a storage unit which stores a syntax analysis result of the analysis unit;
a generation unit which generates an intermediate code from the script program by use of the syntax analysis result stored in the storage unit, when execution of the application is instructed; and
an execution unit which executes the intermediate code generated by the generation unit.

6. The optical disk device according to claim 5, in which the plurality of script programs include a plurality of functions, respectively, and the intermediate code generation unit generates the intermediate codes of the functions, the optical disk device further comprising:
a judgment unit which judges equivalences of the functions,
wherein in a case where the judgment unit judges that the functions equivalent to each other are present in different applications, the execution unit shares the intermediate code of the function converted by the execution of one application, in the different applications.

7. The optical disk device according to claim 5, wherein the analysis unit preferentially interprets a syntax of the script program of a last-reproduced title at a time when a power supply of the optical disk is turned on.

8. The optical disk device according to claim 5, wherein the script program is a program described by an ECMAscript.

9. An script program execution method of executing a script program described in a script language, comprising:
beforehand reading the script program to analyze a syntax of the script program, before the execution of the script program is instructed;
storing a syntax analysis result of the script program;
generating an intermediate code from the script program by use of the stored syntax analysis result, when the execution of the script program is instructed; and
executing the generated intermediate code.

10. The script program execution method according to claim 9, in which the script program includes a plurality of functions and the intermediate codes of the functions are generated in the generation of the intermediate code, the script program execution method further comprising:
judging equivalences of the functions,
wherein during the execution of the intermediate code, in a case where it is judged that the functions equivalent to each other are present in the script program, the intermediate code of the function generated by the execution of one function is shared during the execution of the other function.
